(19) United States
(12) Patent Application Publication
(10) Pub. No.: US 2006/0199922 A1
(43) Pub. Date: Sep. 7, 2006

(54) Oxygen scavenging polyesters with reduced recycle color

(75) Inventors: James H. Pawlow, Akron, OH (US); William L. Hergenrother, Akron, OH (US); Daniel F. Graves, Canal Fulton, OH (US)

Correspondence Address: Chief IP Counsel;Bridgestone Americas Holding, Inc., 1200 Firestone Parkway, Akron, OH, 44317, US

(73) Assignee: Firestone Polymers, LLC

(21) Appl. No.: 11/364,916

(22) Filed: Mar. 1, 2006

Related U.S. Application Data
(60) Provisional application No. 60/657,291, filed on Mar. 1, 2005.

(51) Int. Cl. C08L 67/02; C08L 9/00

(52) U.S. Cl. 525/445; 525/165

(57) ABSTRACT

A composition comprising (i) an aromatic polyester resin, and (ii) a polydiene, where greater than 20 mole percent of the mer units of said polydiene have a 1,2 microstructure or the hydrogenated residue thereof.

This application gains the benefit of U.S. Provisional Application No. 60/657,291, filed Mar. 1, 2005, which is incorporated herein by reference.

### FIELD OF THE INVENTION

This invention relates to polyester compositions that include polydienes.

### BACKGROUND OF THE INVENTION

Polyester resins, such as poly(ethylene terephthalate) are commonly used to fabricate containers that are useful in food and beverage packaging. These resins, however, have limited packaging life, especially in the packaging of food and beverages that are sensitive to oxygen.

To overcome these shortcomings, these resins have been blended or reacted with unsaturated polymers such as polybutadiene. It is believed that the presence of the unsaturation within the polymer serves to scavenge oxygen that attempts to permeate through the package.

Unfortunately, the presence of these unsaturated polymers within the polyester composition leads to recycling difficulty. Namely, these compositions are not desirable for recycling because of the formation of color during the drying cycle. In particular, these compositions have suffered from the formation of red and yellow discoloration.

Inasmuch as use of these polyesters remains desirable, and the ability to recycle these resins is technologically important, there is a need to overcome problems associated with the formation of color within these resins.

### SUMMARY OF THE INVENTION

In one or more embodiments, the present invention provides a composition comprising (i) an aromatic polyester resin, and (ii) a polydiene, where greater than 20 mole percent of the mer units of said polydiene have a 1,2 microstructure or the hydrogenated residue thereof.

In one or more embodiments the present invention also includes a method of making a polymeric composition, the method comprising anionically polymerizing conjugated diene monomer to form a polydiene, and introducing an aromatic polyester and the polydiene.

### DETAILED DESCRIPTION OF ILLUSTRATIVE EMBODIMENTS

One or more embodiments of this invention are directed to an aromatic polyester resin composition that includes a polydiene. In one or more embodiments, the polydiene may be prepared by anionic polymerization techniques. In one or more embodiments, the polydiene includes greater than 20 percent mer units in the vinyl position or the hydrogenated residue of a vinyl unit. In one or more embodiments, the composition is formed by combining an aromatic polyester resin and a polydiene including at least one hydroxyl group. In one or more embodiments, the aromatic polyester resin and polydiene are covalently bonded to form a copolymer.

Practice of this invention is not limited by the selection of a particular aromatic polyester resin. In one or more embodiments, aromatic polyester resins derive from aromatic dicarboxylic acids and diols. Exemplary dicarboxylic acids include terephthalic acid, isophthalic acid, naphthalenedicarboxylic acid, diphenyl ether carboxylic acid, diphenyl dicarboxylic acid, diphenyl sulfone dicarboxylic acid, diphenoxyethanedicarboxylic acid, and mixtures thereof. In one or more embodiments, the polyesters may derive from derivatives of these acids such as dimethyl esters thereof. Exemplary diols include ethylene glycol, trimethylene glycol, tetramethylene glycol, neopentyl glycol, hexamethylene glycol, cyclohexanedimethanol, tricyclodecanedimethanol, 2,2-bis(4-hydroxy ethoxy phenyl)propane, 4,4′-bis(hydroxy ethoxy)diphenyl sulfone, diethylene glycol and mixtures thereof.

Examples of aromatic polyesters that may be employed in one or more embodiments include poly(alkylene terephthalate) resins such as poly(ethylene terephthalate), poly(butylene terephthalate), and poly(cyclohexane dimethylene terephthalate). Others include poly(alkylene naphthalate) resins such as poly(ethylene naphthalate), poly(butylene naphthalate), and poly(cyclohexane dimethylene naphthalate).

In one or more embodiments, the aromatic polyester resin may be characterized by an intrinsic viscosity that is in excess of 0.5 dl/g, in other embodiments in excess of 0.6 dl/g, and in other embodiments in excess of 0.7 dl/g, where the intrinsic viscosity is measured at 25° C. in a 50/50 blend of phenol and 1,1,2,2-tetrachloroethane. In these or other embodiments, the aromatic polyester resin may be characterized by an intrinsic viscosity that is less than 1.2 dl/g, in other embodiments less than 1.0 dl/g, and in other embodiments less than 0.95 dl/g.

In one or more embodiments, the aromatic polyester resin may be characterized by a melt temperature that is in excess of 200° C., in other embodiments in excess of 220° C., and in other embodiments in excess of 230° C.

In one or more embodiments, the aromatic polyester resins include those that are prepared from dimethyl terephthalate and ethylene glycol by a two-stage esterification process. Others include those prepared by direct esterification of a diacid with a diol or esterification of the diacid with ethylene oxide. Other methods for producing desirable resins for use in this invention are also known such as those methods described in U.S. Pat. No. 6,083,585, which is incorporated herein by reference.

Useful poly(alkylene terephthalate) resins may be obtained under the tradename Mylar (DuPont), Dacron (DuPont), Terylene (ICI Chemicals).

In one or more embodiments, the polydiene includes butadienyl, pentadienyl, and isoprenyl mer units. In one or more embodiments, the polydiene also includes styrenyl units. Exemplary polydienes include poly(butadiene), poly(isoprene), poly(butadiene-co-isoprene), poly(styrene-co-butadiene), poly(styrene-co-isoprene), poly(styrene-co-isoprene-co-butadiene), and mixtures thereof.

In one or more embodiments, the polydienes may be characterized by a microstructure where greater than 20 percent of its mer units are positioned in the vinyl configuration (i.e., 1,2 configuration in the case of polybutadiene or 1,2 or 3,4 configuration in the case of polyisoprene) or the hydrogenated residue of a vinyl unit. As those skilled in the art appreciate, the hydrogenated residue of a vinyl unit is a pendent ethyl unit (or an isopropyl group in the case of 3,4 configuration of polyisoprene). In other embodiments, at lest 22 percent, in other embodiments at least 25 percent, in other embodiments at least 30 percent, in other embodiments at least 35 percent, and in other embodiments at least 40 percent of the mer units of the polydiene may be positioned in the vinyl configuration or the hydrogenated residue thereof. In one or more embodiments, the polydienes may be characterized by a microstructure where less than 85 percent of its mer units are positioned in the vinyl configuration or the hydrogenated residue thereof. In these or other embodiments, less than 70 percent, in other embodiments less than 65 percent, in other embodiments less than 60 percent, in other embodiments less than 55 percent, and in other embodiments less than 40 percent of the mer units of the polydiene may be positioned in the vinyl configuration or the hydrogenated residue thereof.

In one or more embodiments, the polydienes may be characterized by a number average molecular weight (Mₙ) of at least 0.5 kg/mole, in other embodiments at least 1 kg/mole, in other embodiments at least 1.5 kg/mole, and in other embodiments at least 2.0 kg/mole. In one or more embodiments, the polydienes may be characterized by a number average molecular weight of less than 100 kg/mole, in other embodiments less than 80 kg/mole, in other embodiments less than 60 kg/mole, and in other embodiments less than 40 kg/mole. In one or more embodiments, the polydienes may be characterized by a molecular weight distribution (Mw/Mn) of from about 1.01 to about 2, in other embodiments from about 1.05 to about 1.9, and in other embodiments from about 1.1 to about 1.8.

In one or more embodiments, the polydienes include at least one hydroxyl group. In certain embodiments, the polydienes include two terminal hydroxyl groups, with each hydroxyl group being positioned at one of two termini of a linear polydiene.

In one or more embodiments, the number of hydroxyl groups may be quantified by a functionality number. In one embodiment, the polydiene is characterized by a functionality of at least 0.8, in other embodiments a functionality of at least 1.4, and in other embodiments a functionality of at least 1.6.

In one or more embodiments, the polydiene can be partially hydrogenated. In one or more embodiments, the degree of hydrogenation can be quantified based upon the number of double bonds (i.e., olefinic double bonds) remaining after hydrogenation. In one embodiment, about 20 to about 60 double bonds per 100 repeat units remain after hydrogenation, in other embodiments about 20 to about 80, in other embodiments about 30 to about 60, in other embodiments about 35 to about 50, in other embodiments about 30 to about 50 double bonds per 100 repeat units remain after hydrogenation, and in other embodiments about 35 to about 45 double bonds per 100 repeat units remain after hydrogenation.

In other embodiments, the degree of hydrogenation can be expressed in terms of the percentage of double bonds (i.e., original olefinic double bonds) remaining after hydrogenation. In one embodiment, at least about 20%, in other embodiments at least about 30%, and in other embodiments at least about 40% of the original double bonds remain after hydrogenation. In these or other embodiments, up to 90%, in other embodiments up to 80%, in other embodiments up to 70%, and in other embodiments up to 60% of the original double bonds remain after hydrogenation. In these or other embodiments, the polydiene is from about 10 to about 90% hydrogenated, in other embodiments from about 30 to about 80% hydrogenated, and in other embodiments from about 50 to about 70% hydrogenated.

In one or more embodiments, the degree of hydrogenation can be quantified based upon the number of vinyl units remaining after hydrogenation. In one or more embodiments, the number of vinyl units remaining after hydrogenation less than 10 mole percent, in other embodiments less than 5 mole percent, in other embodiments less than 2 mole percent, in other embodiments less than 1 mole percent, in other embodiments less than 0.5 mole percent, in other embodiments less than 0.25 mole percent, and in other embodiments less than 0.1 mole percent. In one embodiment, the level of hydrogenation is such that all vinyl units are hydrogenated and therefore the polymer is devoid of vinyl units (i.e., only the hydrogenated residue of the vinyl units remains). As those skilled in the art appreciate, mole percent refers to the number of vinyl units present in the polymer based upon the total number of double bonds (i.e., olefinic double bonds) within the polymer.

One particular polydiene includes poly(butadiene) that is characterized by a hydroxyl functionality of from about 1.6 to about 1.9, a vinyl content of from about 20 to about 70, a number average molecular weight of from about 2 kg/mol to about 10 kg/mol, a weight average molecular weight of from about 2 kg/mol to about 20 kg/mol, and from about 60 to about 80% of the original double bonds remain after hydrogenation.

The polydienes may be prepared by employing conventional anionic polymerization techniques. Anionically-polymerized living polymers may be formed by reacting anionic initiators with certain unsaturated monomers to propagate a polymeric structure. Throughout formation and propagation of the polymer, the polymeric structure may be anionic and “living.” A new batch of monomer subsequently added to the reaction can add to the living ends of the existing chains and increase the degree of polymerization. A living polymer, therefore, includes a polymeric segment having a living or reactive end. Anionic polymerization is further described in George Odian, Principles of Polymerization, ch. 5 (3^{rd} Ed. 1991), or Panek, 94 J. Am. Chem. Soc., 8768 (1972), which are incorporated herein by reference.

Monomers that can be employed in preparing an anionically polymerized living polymer include any monomer capable of being polymerized according to anionic polymerization techniques. These monomers include those that lead to the formation of elastomeric homopolymers or copolymers. Suitable monomers include, without limitation, conjugated C₄-C₁₂ dienes, C₈-C₁₈ monovinyl aromatic monomers, and C₆-C₂₀ trienes. Examples of conjugated diene monomers include, without limitation, 1,3-butadiene, isoprene, 1,3-pentadiene, 2,3-dimethyl-1,3-butadiene, and 1,3-hexadiene. A non-limiting example of trienes includes myrcene.

Any anionic initiator can be employed to initiate the formation and propagation of the living polymers. Exemplary anionic initiators include, but are not limited to, alkyl lithium initiators such as n-butyl lithium, arenyllithium initiators, arenylsodium initiators, aminoalkyllithiums, protected hydroxy alkyl lithiums, and alkyl tin lithiums. Initiators including protected functional groups, such as protected hydroxyl groups, are disclosed in U.S. Pat. Nos. 5,362,699; 5,331,058; 5,565,526; and 5,922,810, which are incorporated herein by reference.

The amount of initiator employed in conducting anionic polymerizations can vary widely based upon the desired polymer characteristics. In one or more embodiments, from about 0.1 to about 100, and optionally from about 0.33 to about 10 mmol of lithium per 100 g of monomer is employed.

Anionic polymerizations are typically conducted in a polar solvent such as tetrahydrofuran (THF) or a nonpolar hydrocarbon such as the various cyclic and acyclic hexanes, heptanes, octanes, pentanes, their alkylated derivatives, and mixtures thereof, as well as benzene.

In order to promote randomization in copolymerization and to control vinyl content, a polar coordinator may be added to the polymerization ingredients. Amounts range between 0 and 90 or more equivalents per equivalent of lithium. The amount depends on the amount of vinyl desired, and the temperature of the polymerization, as well as the nature of the specific polar coordinator (modifier) employed. Suitable polymerization modifiers include, for example, ethers or amines to provide the desired microstructure and randomization of the comonomer units.

Compounds useful as polar coordinators include those having an oxygen or nitrogen heteroatom and a non-bonded pair of electrons. Examples include dialkyl ethers of mono and oligo alkylene glycols; “crown” ethers; tertiary amines such as tetramethylethylene diamine (TMEDA); linear THF oligomers; and the like. Specific examples of compounds useful as polar coordinators include tetrahydrofuran (THF), linear and cyclic oligomeric oxolanyl alkanes such as 2,2-bis(2′-tetrahydrofuryl) propane, di-piperidyl ethane, dipiperidyl methane, hexamethylphosphoramide, N-N′-dimethylpiperazine, diazabicyclooctane, dimethyl ether, diethyl ether, tributylamine and the like. The linear and cyclic oligomeric oxolanyl alkane modifiers are described in U.S. Pat. No. 4,429,091, incorporated herein by reference.

Anionically polymerized living polymers can be prepared by either batch, semi-continuous, or continuous methods. A batch polymerization is begun by charging a blend of monomer(s) and normal alkane solvent to a suitable reaction vessel, followed by the addition of the polar coordinator (if employed) and an initiator compound. The reactants are heated to a temperature of from about 20 to about 130° C. and the polymerization is allowed to proceed for from about 0.1 to about 24 hours. This reaction produces a reactive polymer having a reactive or living end. Preferably, at least about 30% of the polymer molecules contain a living end. More preferably, at least about 50% of the polymer molecules contain a living end. Even more preferably, at least about 80% contain a living end.

In one or more embodiments, the polydienes may be prepared by employing a multi-functional initiator. The use of multi-functional initiators in anionic polymerization is generally known as described in U.S. Pat. No. 3,652,516, which is incorporated herein by reference. In certain embodiments, the polydienes are prepared by employing a di-lithio initiator such as one prepared by reacting 1,3-diisopropenylbenzene with sec-butyl lithium.

In one or more embodiments, the polydienes may be prepared by an alternate anionic technique that employs a radical anion initiator. These techniques are generally known in the art as described in U.S. Pat. No. 5,552,483, which is incorporated herein by reference. In one embodiment, the radical anion polymerization technique employs a naphthalene anion-radical that is believed to transfer an electron to a monomer such as 1,3-butadiene to form a butadienyl radical-anion. The naphthalene anion-radical can be formed by reacting an alkali metal, such as sodium, with naphthalene. In one or more embodiments, the butadienyl radical-anion dimerizes to form a dicarbanion. It is believed that the addition of additional monomer converts the dicarbanion to a di-living polymer.

In one or more embodiments, the polydiene includes one or more terminal hydroxyl groups. The invention is not limited by the particular method by which the polydiene is functionalized to provide the hydroxyl group. In one or more embodiments, hydroxyl-functionalized polydiene is formed by terminating a living polymer with an alkylene oxide (i.e., epoxide) such as ethylene oxide or propylene oxide. Where the polydiene is di-living, then termination with sufficient alkylene oxide may form a di-hydroxy polydiene, with hydroxyl groups at each end of the polydiene.

In one or more embodiments, the anionically polymerized polymer can be recovered or separated from the solvent from which may be polymerized by employing conventional techniques. These techniques may include desolventization and drying such as steam desolventization or hot water coagulation followed by filtration. Residual solvent may removed by using conventional drying techniques such as oven drying or drum drying. Alternatively, the cement may be dried by thin film evaporators.

In one or more embodiments, efforts can be made to remove residual lithium from the polydiene product. Conventional techniques for removing residual metals from polymer compositions can be employed.

In one or more embodiments, the polydiene may be hydrogenated by treating a polydiene with a homogeneous or heterogeneous transition metal catalyst system. Alternatively, organic systems such as diimide systems (e.g., hydrazine) may be employed. Hydrogenation techniques and catalysts for use in hydrogenation are well known as described in “Chemical Modification of Polymers: Catalytic Hydrogenation and Related Reactions” by McManus et al., J.M.S.-Rev. Macromol. Chem. Phys., C35(2), 239-285 (1995), “Coordination Catalyst for the Selective hydrogenation of Polymeric Unsaturation,” by Falk, Journal of Polymer Science: Part A-1, Vol. 9, 2617-2623 (1971), “The Hydrogenation of HO-Terminated Telechelic Polybutadienes in the Presence of a Homogeneous Hydrogenation Catalyst Based on Tris(triphenylphosphine)rhodium Chloride” by Bouchal et al., Institute of Macromolecular Chemistry, Die Angewandte Makromolekular Chemie 165, 165-180 (Nr. 2716) (1989), Hydrogenation of Low Molar Mass OH-Telechelic Polybutadienes Catalyzed by Homogeneous Ziegler Nickel Catalysts, by Sabata et al., Journal of Applied Polymer Science, Vol. 85, 1185-1193 (2002), “An Improved Method for the Diimide Hydrogenation of Butadiene and Isoprene Containing Polymers, by Hahn, Journal of Polymer Science: Part A: Polymer Chemistry, Vol. 30, 397-408 (1992), and Hydrogenation of Low-Molar-Mass, OH-Telechelic Polybutadienes. I. Methods Based on Diimide” by Holler, Journal of Applied Polymer Science, Vol 74, 3203-3213 (1999), which are incorporated herein by reference. Partial hydrogenation of conjugated dienes is described in U.S. Pat. Nos. 4,590,319, 5,242,986, and 6,184,307, all of which are hereby incorporated by reference. Partial hydrogenation of aromatic hydrocarbons to form cycloalkenes is described more fully in U.S. Pat. Nos. 4,197,415, 4,392,001, and 5,589,600, all of which are hereby incorporated by reference.

In one or more embodiments of this invention, the compositions can be prepared by mixing or blending the aromatic polyester resin and the polydiene. Techniques for mixing are known in the art, and this invention is not necessarily limited to the selection of a particular method. In one embodiment, the mixing occurs in a reactive extruder such as a twin-screw extruder.

The mixing or blending of the polyester resin and the polydiene can occur over a wide range of conditions. In one or more embodiments, the mixing or blending can occur at a temperature of from about 230° C. to about 310° C. and in other embodiments from about 250° C. to about 290° C.

In one or more embodiments, the residence time within the extruder is maintained for about 2 to about 6 minutes, and in other embodiments from about 3 to about 5 minutes.

In one or more embodiments, the polyester resin and polydiene may be mixed or blended in the presence of catalysts, modifiers, heat stabilizers, antioxidants, colorants, crystallization nucleating agents, fillers, biodegradation accelerants or additional constituents that can be incorporated into the composition. In general, aromatic polyester compositions are known as described in U.S. Pat. No. 6,083,585, which is incorporated herein by reference.

In one or more embodiments, the aromatic polyester composition further includes a transition metal catalyst such as an oxygen scavenging catalyst. In one or more embodiments, the polyester resin and the polydiene are mixed or blended in the presence of the oxygen scavenging catalyst. Useful oxygen scavenging catalysts include cobalt compounds. Useful cobalt compounds include cobalt carboxylates, cobalt organophosphates, cobalt organophosphonates, cobalt organophosphinates, cobalt carbamates, cobalt dithiocarbamates, cobalt xanthates, cobalt β-diketonates, cobalt alkoxides or aryloxides, cobalt halides, cobalt pseudo-halides, cobalt oxyhalides, and organocobalt compounds.

Useful cobalt carboxylates include cobalt octoate, cobalt 2,-ethylhexanoate, cobalt neodecanoate, cobalt naphthenate, cobalt stearate, and mixtures thereof.

In one or more embodiments, the aromatic polyester compositions of this invention include from about 0.05 to about 0.15 weight percent cobalt based upon the weight of the polydiene. In other embodiments, the composition includes from about 0.07 to about 0.12 weight percent, and in other embodiments from about 0.09 to about 0.11 weight percent cobalt based upon the weight of the polydiene.

In one or more embodiments, the aromatic polyester compositions may include or be modified by condensation branching or coupling agents that alter the intrinsic viscosity of the compositions. In other words, the compositions include the reaction product between the branching agent and the aromatic polyester and/or polydiene. These agents may include polycondensate branching agents. In one or more embodiments, these branching agents may include trimellitic anhydride, aliphatic dianhydrides and aromatic dianhydrides. In one embodiment, pyromellitic dianhydride (i.e., benzene 1,2,4,5-tetracarboxylicacid dianhydrides) is employed.

Numerous factors can alter the amount of branching agent that may be desirable, or alter whether the use of a branching agent may be desired. In one embodiment, the amount of mono-functionalized polydiene present within the composition may impact the amount of branching agent employed. In one or more embodiments, the composition of this invention includes or is modified by from about 0.01 to about 0.15 weight percent branching agent based upon the weight of the polydiene. In other embodiments, the composition includes from about 0.05 to about 0.12 weight percent, and in other embodiments from about 0.09 to about 0.11 weight percent branching agent based upon the weight of the polydiene.

In one or more embodiments of this invention, the composition including the aromatic polyester resin and polydiene are prepared as concentrates or masterbatches that can be subsequently added to other thermoformable resins (e.g., aromatic polyester resins) for use in preparing particular articles. In forming these concentrates, which are often in the form of pellets, the composition of this invention may include at least 1%, in other embodiments at least 5%, and in other embodiments at least 10% by weight polydiene based upon the total weight of the polydiene and aromatic polyester resin. In these or other embodiments, these concentrates or masterbatch pellets include less than 30%, and in other embodiments less than 20%, and in other embodiments less than 15% by weight polydiene based upon the total weight of the polydiene and aromatic polyester resin.

In one or more embodiments of this invention, particularly where the composition is employed in thermoforming process (as opposed to the manufacture of concentrate or masterbatch pellets), the compositions include at least 0.05%, in other embodiments at least 0.5%, and in other embodiments at least 0.9% by weight polydiene based upon the total weight of the polydiene and the aromatic polyester resin. In these or other embodiments, the thermoformable composition includes less than 5%, in other embodiments less than 3%, and in other embodiments less than 1.5% by weight polydiene based upon the total weight of the polydiene and the aromatic polyester resin.

In one or more embodiments, the composition of the invention includes the reaction product between an aromatic polyester resin and hydroxy-terminated polydiene. It is believed that the polyester and hydroxy-terminated polydiene react via a condensation reaction.

In one or more embodiments, the compositions of this invention include an aromatic polyester resin matrix having dispersed therein domains of the polydiene. As those skilled in the art appreciate, the characteristics, especially the size, of these polydiene domains can be adjusted based upon mixing conditions and/or the functionality of the polydiene. In one or more embodiments, the polydiene domains are characterized by an average diameter of less than 400 nanometers, in other embodiments less than 300 nanometers, and in other embodiments less than 200 nanometers.

In one or more embodiments, the compositions of this invention are advantageously thermoformable, and therefore they can be used in the various thermoforming techniques that are known such as, but not limited to, injection molding, blow molding, and compression molding. In one or more embodiments, the compositions of this invention can also be extruded.

In one or more embodiments, the compositions can be used to fabricate packaging walls and packaging articles. In certain embodiments, these packaging articles include those used with perishable foods and beverages, particularly those foods and beverages that degrade in the presence of oxygen. Numerous packaging articles for these uses are known as described in U.S. Pat. No. 6,083,585, which is incorporated herein by reference.

In one particular use, the compositions of this invention can be used to fabricate bottles. In other embodiments, the compositions can be used in the manufacture of packaging films.

The compositions of one or more embodiments of this invention are advantageously recyclable without the formation of a deleterious color.

In order to demonstrate the practice of the present invention, the following examples have been prepared and tested. The examples should not, however, be viewed as limiting the scope of the invention. The claims will serve to define the invention.

### EXAMPLES

Dilithium Initiator Preparation

In a dry, nitrogen-purged, 300 mL bottle capped with a nitrile rubber septum, 8 mL (7.4 g, 47 mmol) of dry, distilled 1,3-diisopropenylbenzene and 13.2 mL (9.6 g, 94 mmol) dry, distilled triethylamine were combined. Via syringe, 65.0 mL of 1.44 M sec-BuLi (94 mmol) was added to the contents of the bottle. Upon addition of the alkyllithium, the solution immediately turned dark red. The contents of the bottle were heated at 50° C. for 2 hours, producing a difunctional lithium initiator at a concentration of 0.54 M. The initiator solution was then immediately used for anionic polymerization.

Synthesis of Low Molecular Weight, Medium Vinyl, Telechelic Hydroxyl-Terminated BR

A batch mixture comprised of 3.71 kg dry hexanes and 0.43 kg of a 21.4 weight percent 1,3-butadiene solution in hexanes were charged into a 7 liter volume reactor and stirred (2.5% solids). Approximately 0.23 kg of the polar modifier THF (3.2 mol, 45:1 THF:Li) was charged into the vessel and the reactor contents were heated. When the temperature of the resulting mixture reached 50° C., 66.5 mL of a 0.54 M dilithium initiator (72 mmol Li) solution was added to the monomer solution. Within 5 minutes, polymerization of the monomer began to occur, and a reaction temperature increase to 55° C. was observed. The resulting cement was then stirred at a constant 50° C. temperature for an additional 2 hours. At this time, 7.0 g (150 mmol) of dry ethylene oxide was added to the polymer solution and stirred at 75° C. in order to functionalized the polymer terminus the anionic lithium sites. After the ethylene oxide was added, the solution viscosity noticeably increased due to the formation of ionic association. After 12 hours, 10 g of isopropanol was added to the reactor contents to terminate the reaction, which reduced this viscosity below that of the lithiated polymer. The resulting polymer had the following characteristics: Mₙ=2.9 kg/mol; M_{w}/Mₙ=1.5; 1,2-vinyl content=70%; and f=1.7 (functionality).

Various modifications and alterations that do not depart from the scope and spirit of this invention will become apparent to those skilled in the art. This invention is not to be duly limited to the illustrative embodiments set forth herein.

What is claimed is:

1. A composition comprising:
(i) an aromatic polyester resin; and
(ii) a polydiene, where greater than 20 mole percent of the mer units of said polydiene have a 1,2 microstructure or the hydrogenated residue thereof.

2. The composition of claim 1, where at least 25 percent of the mer units of said polydiene have a 1, 2 microstructure or the hydrogenated residue thereof.

3. The composition of claim 2, where less than 85 percent of the mer units of said polydiene have a 1, 2 microstructure or the hydrogenated residue thereof.

4. The composition of claim 1, where the aromatic polyester resin includes poly(ethylene terephthalate), poly(butylene terephthalate), or copolymer or mixtures thereof.

5. The composition of claim 1, where said polydiene includes poly(butadiene).

6. The composition of claim 1, where said polydiene is formed by anionic polymerization by using a lithium-containing initiator in the presence of a vinyl modifier.

7. The composition of claim 1, where said polydiene is characterized by a weight average molecular weight of from about 1 to about 25 kg/mol.

8. The composition of claim 4, where said aromatic polyester is poly(alkylene terephthalate), and where the poly(alkylene terephthalate) is characterized by an intrinsic viscosity of at least 0.5 dl/g at 25° C.

9. The composition of claim of claim 1, where said polydiene includes a hydroxyl group.

10. The composition of claim 9, where said polydiene includes a hydroxy-terminated polydiene.

11. The composition of claim 10, where said hydroxy-terminated polydiene includes a polydiene including about two hydroxyl groups.

12. The composition of claim 10, where said hydroxy-terminated polydiene includes di-hydroxy poly(butadiene).

13. The composition of claim 10, where said hydroxy-terminated polydiene is prepared by initiating the polymerization of 1,3-butadiene with a di-lithio initiator, and terminating the polymerization with an alkylene oxide.

14. The composition of claim 9, where said hydroxyl group derives from a protected initiator.

15. The composition of claim 1, where the composition includes at least about 0.5% by weight polydiene based upon the total weight of the polydiene and aromatic polyester resin.

16. The composition of claim 1, where the composition includes at least about 0.9% by weight polydiene based upon the total weight of the polydiene and aromatic polyester resin.

17. The composition of claim 1, further comprising a cobalt compound.

18. The composition of claims 1, where said aromatic polyester copolymer and said polydiene are covalently bonded to each other via an ester linkage.

19. The composition of claim 1, further comprising the reaction product of or mixture of a dianhydride branching agent.

20. The composition of claim 1, where the polydiene includes a partially hydrogenated polydiene.

21. The composition of claim 20, where the hydrogenation results in at least 20% Up to 90% of the original double bonds remaining after hydrogenation.

22. The composition of claim 21, where the hydrogenation results in at least 30% up to 80% of the original double bonds remaining after hydrogenation.

23. A method of making a polymeric composition, the method comprising:
anionically polymerizing conjugated diene monomer to form a polydiene; and
introducing an aromatic polyester and the polydiene.

24. The method of claim 23, where said aromatic polyester includes a poly(alkylene terephthalate) resin.

25. The method of claim 23, where poly(alkylene terephthalate) resin includes poly(ethylene terephthalate), poly(butylene terephthalate), or copolymer or mixtures thereof.

26. The method of claim 23, where said anionically polymerizing includes terminating the polydiene with an alkylene oxide.

27. The method of claim 24, where said anionically polymerizing includes initiating the polymerization with an initiator including a protected hydroxyl group.

28. The method of claim 23, further comprising the step of partially hydrogenating the polydiene prior to said step of introducing.
